(19) United States
(12) Patent Application Publication
(10) Pub. No.: US 2014/0010278 A1
(43) Pub. Date: Jan. 9, 2014

(54) METHOD AND APPARATUS FOR CODING ADAPTIVE-LOOP FILTER COEFFICIENTS

(71) Applicant: MOTOROLA MOBILITY LLC, Libertyville, IL (US)

(72) Inventors: Jian Lou, San Diego, CA (US); Limin Wang, San Diego, CA (US); Yue Yu, San Diego, CA (US)

(21) Appl. No.: 13/932,025

(22) Filed: Jul. 1, 2013

Related U.S. Application Data
(60) Provisional application No. 61/669,136, filed on Jul. 9, 2012.

(51) Int. Cl. H04N 7/26

(52) U.S. Cl. CPC H04N 19/00066
USPC 375/240.02

(57) ABSTRACT

Disclosed is a method and apparatus for encoding adaptive-loop filter (“ALF”) coefficients. An encoder or decoder codes the ALF coefficients by using k-variable Exp-Golomb codewords where k is larger than 0, and k is the same for each coefficient. This eliminates the need for a k-parameter mapping table.

### TECHNICAL FIELD

The present disclosure is related generally to video coding and, more particularly, to coding the coefficients of adaptive-loop filters that are used in video coding.

### BACKGROUND

Video compression (i.e., coding) systems generally employ block processing for most compression operations. A block is a group of neighbouring pixels and is considered a “coding unit” for purposes of compression. Theoretically, a larger coding unit size is preferred to take advantage of correlation among immediate neighbouring pixels. Certain video coding standards, such as Motion Picture Expert Group (“MPEG”)-1, MPEG-2, and MPEG-4, use a coding unit size of 4 by 4, 8 by 8, or 16 by 16 pixels (known as a macroblock).

High efficiency video coding (“HEVC”) is an alternative video coding standard that also employs block processing. As shown in FIG. 1, HEVC partitions an input picture 100 into square blocks referred to as largest coding units (“LCUs”). Each LCU can be as large as 128 by 128 pixels and can be partitioned into smaller square blocks referred to as coding units (“CUs”). For example, an LCU can be split into four CUs, each being a quarter of the size of the LCU. A CU can be further split into four smaller CUs, each being a quarter of the size of the original CU. This partitioning process can be repeated until certain criteria are met. FIG. 2 illustrates an LCU 200 that is partitioned into seven CUs (202-1, 202-2, 202-3, 202-4, 202-5, 202-6, and 202-7). As shown, CUs 202-1, 202-2, and 202-3 are each a quarter of the size of LCU 200. Further, the upper right quadrant of LCU 200 is split into four CUs 202-4, 202-5, 202-6, and 202-7, which are each a quarter of the size of a quadrant.

Each CU includes one or more prediction units (“PUs”). FIG. 3 illustrates an example CU partition 300 that includes PUs 302-1, 302-2, 302-3, and 302-4. The PUs are used for spatial or temporal predictive coding of CU partition 300. For instance, if CU partition 300 is coded in “intra” mode, each PU 302-1, 302-2, 302-3, and 302-4 has its own prediction direction for spatial prediction. If CU partition 300 is coded in “inter” mode, each PU 302-1, 302-2, 302-3, and 302-4 has its own motion vectors and associated reference pictures for temporal prediction.

Further, each CU-partition of PUs is associated with a set of transform units (“TUs”). Like other video coding standards, HEVC applies a block transform on residual data to decorrelate the pixels within a block and to compact the block energy into low-order transform coefficients. However, unlike other standards that apply a single 4 by 4 or 8 by 8 transform to a macroblock, HEVC can apply a set of block transforms of different sizes to a single CU. The set of block transforms to be applied to a CU is represented by its associated TUs. By way of example, FIG. 4 illustrates CU partition 300 of FIG. 3 (including PUs 302-1, 302-2, 302-3, and 302-4) with an associated set of TUs 402-1, 402-2, 402-3, 402-4, 402-5, 402-6, and 402-7. These TUs indicate that seven separate block transforms should be applied to CU partition 300, where the scope of each block transform is defined by the location and size of each TU. The configuration of TUs associated with a particular CU can differ based on various criteria.

Once a block transform operation has been applied with respect to a particular TU, the resulting transform coefficients are quantized to reduce the size of the coefficient data. The quantized transform coefficients are then entropy coded, resulting in a final set of compression bits. HEVC currently offers an entropy coding scheme known as context-based adaptive binary arithmetic coding (“CABAC”). CABAC can provide efficient compression due to its ability to adaptively select context models (i.e., probability models) for arithmetically coding input symbols based on previously coded symbol statistics. However, the context model selection process in CABAC (referred to as context modelling) is complex and requires significantly more processing power for encoding and decoding than do other compression schemes.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 illustrates an input picture partitioned into LCUs;

FIG. 2 illustrates an LCU partitioned into CUs;

FIG. 3 illustrates a CU partitioned into PUs;

FIG. 4 illustrates a CU partitioned into PUs and a set of TUs associated with the CU;

FIG. 5 illustrates an encoder for encoding video content;

FIG. 6 illustrates a decoder for decoding video content;

FIG. 7 illustrates a process for encoding and decoding transform coefficients;

FIG. 8 illustrates the relationship between a set of pixels and a set of filter coefficients; and

FIGS. 9 through 12 illustrate methods of coding coefficients of adaptive-loop filters according to various embodiments.

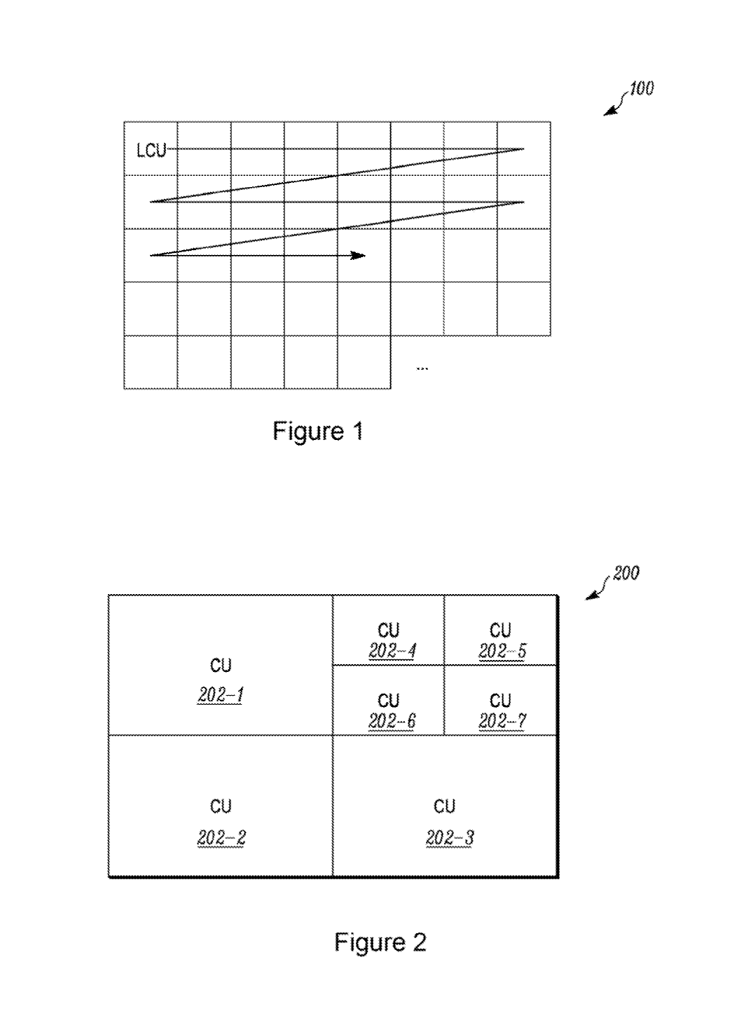

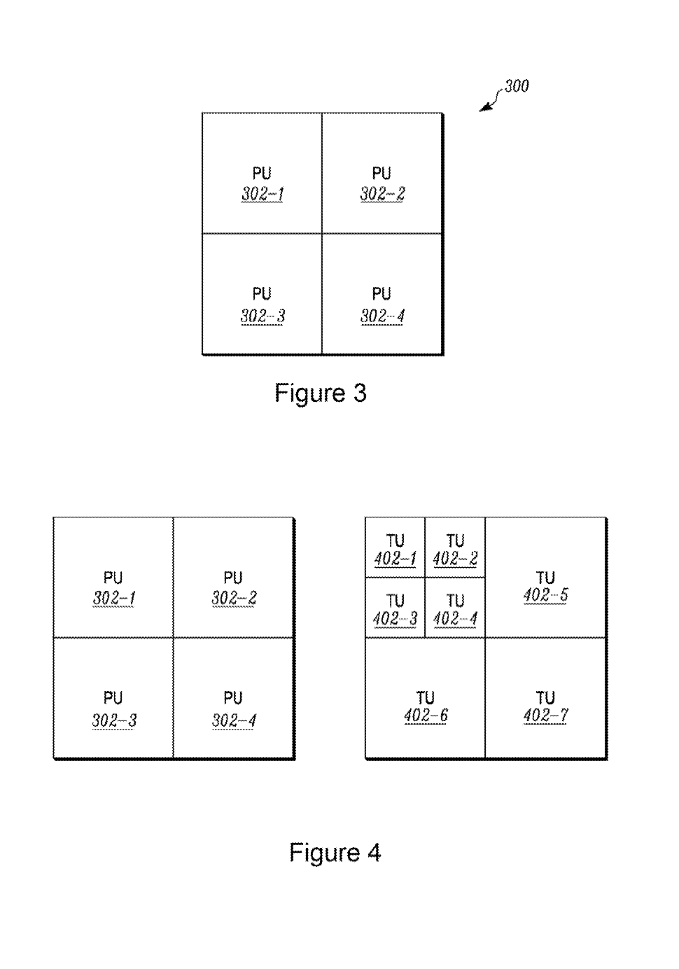

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

The term “coding” as used herein includes both encoding and decoding. Thus, when the present disclosure (including the flowcharts 900, 1000, 1100, and 1200) sets forth steps for coding, persons of ordinary skill in the art recognize that the steps are to be executed in the appropriate order. Thus, an encoder executes the steps in a sequence appropriate for encoding, while a decoder executes them in a sequence appropriate for decoding.

In video coding, as with other types of coding, a major goal is to minimize the amount of memory that the information occupies. In many cases, this means compressing the actual video data. But overhead information also takes up memory and should also be coded efficiently.

In accordance with the foregoing, a method for coding filter coefficients is now described.

One embodiment of the method unifies an HEVC Adaptive-Loop Filter (“ALF”) coefficient coding with coeff_abs_level_remaining coding by using the same binarization scheme for both.

Another embodiment removes the parameter mapping table for the Luma ALF coefficients when the Luma ALF coefficients are binarized and coded with a unary code and a variable length code.

Yet another embodiment uses the same parameter value for different Luma ALF coefficients at different positions when the Luma ALF coefficients are binarized and coded with a unary code and a variable length code.

Still another embodiment uses parameter values of 0, 1, 2, 3, 4, or 5 for different Luma ALF coefficients at different positions when the Luma ALF coefficients are binarized and coded with a unary code and a variable length code.

Still another embodiment uses parameter values of 0, 1, 2, 3, 4, or 5 for different Chroma ALF coefficients at different positions when the Chroma ALF coefficients are binarized and coded with a unary code and a variable length code.

Yet another embodiment removes the parameter mapping table for the Luma ALF coefficients and the Luma ALF coefficients are binarized and coded with k-variable Exp-Golomb codewords where k is larger than 0.

A further embodiment uses k-variable Exp-Golomb codewords for all the Luma ALF coefficient binarization and coding where k could be 1, 2, 3, 4, 5, or larger.

Another embodiment uses k-variable Exp-Golomb codewords for all the Chroma ALF coefficient binarization and coding where k could be 1, 2, 3, 4, 5, or larger.

Another embodiment uses fixed length codewords for all the Luma ALF coefficient binarization and coding where the length could be 4, 5, 6, 7, 8, and larger.

Still another embodiment uses fixed length codewords for all the Chroma ALF coefficient binarization and coding where the length could be 4, 5, 6, 7, 8, and larger.

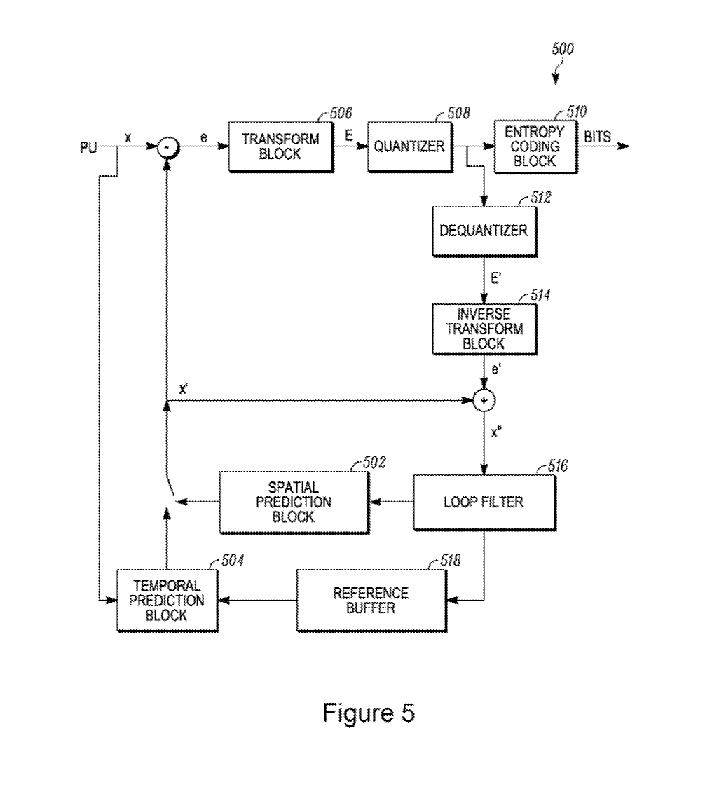

While the embodiments described are suitable in many video coding contexts, FIGS. 5 through 8 describe one example of such a context.

FIG. 5 depicts an example encoder 500 for encoding video content. In one embodiment, encoder 500 can implement the HEVC standard. A general operation of encoder 500 is described below. However, it should be appreciated that this description is provided for illustration purposes only and is not intended to limit the disclosure and teachings herein. One of ordinary skill in the art will recognize various modifications, variations, and alternatives for the structure and operation of encoder 500.

As shown, encoder 500 receives as input a current PU “x.” PU x corresponds to a CU (or a portion thereof), which is in turn a partition of an input picture (e.g., video frame) that is being encoded. Given PU x, a prediction PU “x′” is obtained through either spatial prediction or temporal prediction (via spatial-prediction block 502 or temporal-prediction block 504). PU x′ is then subtracted from PU x to generate a residual PU “e.”

Once generated, residual PU e is passed to a transform block 506, which is configured to perform one or more transform operations on PU e. Examples of such transform operations include the discrete sine transform, the discrete cosine transform (“DCT”), and variants thereof (e.g., DCT-I, DCT-II, DCT-III, etc.). Transform block 506 then outputs residual PU e in a transform domain (“E”), such that transformed PU E comprises a two-dimensional array of transform coefficients. In this block, a transform operation can be performed with respect to each TU that has been associated with the CU corresponding to PU e (as described with respect to FIG. 4 above).

Transformed PU E is passed to a quantizer 508, which is configured to convert, or quantize, the relatively high precision transform coefficients of PU E into a finite number of possible values. After quantization, transformed PU E is entropy coded via entropy-coding block 510. This entropy coding process compresses the quantized transform coefficients into final compression bits that are subsequently transmitted to an appropriate receiver or decoder. Entropy-coding block 510 can use various types of entropy coding schemes, such as CABAC. A particular embodiment of entropy-coding block 510 that implements CABAC is described in further detail below.

In addition to the foregoing steps, encoder 500 includes a decoding process in which a dequantizer 512 dequantizes the quantized transform coefficients of PU E into a dequantized PU “E′.” PU E′ is passed to an inverse transform block 514, which is configured to inverse transform the de-quantized transform coefficients of PU E′ and thereby generate a reconstructed residual PU “e′.” Reconstructed residual PU e′ is then added to the original prediction PU x′ to form a new, reconstructed PU “x″.” A loop filter 516 performs various operations on reconstructed PU x″ to smooth block boundaries and minimize coding distortion between the reconstructed pixels and original pixels. The loop filter 516 can be made up of multiple filters. In the embodiments described below, the loop filter 516 is an ALF. Reconstructed PU x″ is then used as a prediction PU for encoding future frames of the video content. For example, if reconstructed PU x″ is part of a reference frame, then reconstructed PU x″ can be stored in a reference buffer 518 for future temporal prediction.

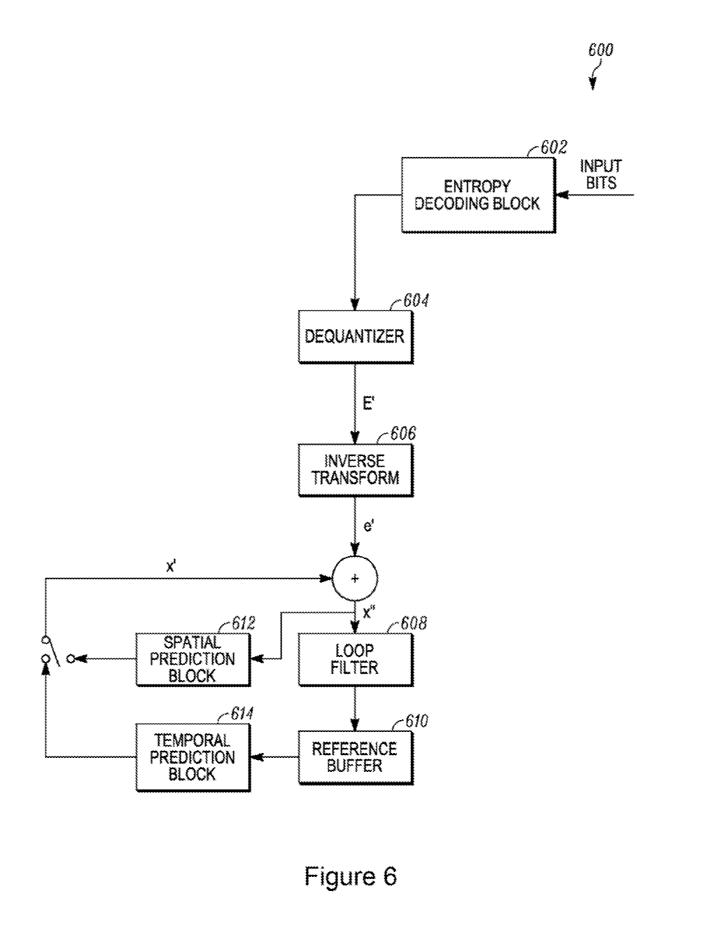

FIG. 6 depicts an example decoder 600 that is complementary to encoder 500 of FIG. 5. Like encoder 500, in one embodiment, decoder 600 can implement the HEVC standard. A general operation of decoder 600 is described below; however, it should be appreciated that this description is provided for illustration purposes only and is not intended to limit the disclosure and teachings herein. One of ordinary skill in the art will recognize various modifications, variations, and alternatives for the structure and operation of decoder 600.

As shown, decoder 600 receives as input a bitstream of compressed data, such as the bitstream output by encoder 500. The input bitstream is passed to an entropy-decoding block 602, which is configured to perform entropy decoding on the bitstream to generate quantized transform coefficients of a residual PU. In one embodiment, entropy-decoding block 602 is configured to perform the inverse of the operations performed by entropy-coding block 510 of encoder 500. Entropy-decoding block 602 can use various different types of entropy coding schemes, such as CABAC. A particular embodiment of entropy-decoding block 602 that implements CABAC is described in further detail below.

Once generated, the quantized transform coefficients are dequantized by dequantizer 604 to generate a residual PU “E′.” PU E′ is passed to an inverse transform block 606, which is configured to inverse transform the dequantized transform coefficients of PU E′ and thereby output a reconstructed residual PU “e′.” Reconstructed residual PU e′ is then added to a previously decoded prediction PU x′ to form a new, reconstructed PU “x″.” A loop filter 608 performs various operations on reconstructed PU x″ to smooth block boundaries and minimize coding distortion between the reconstructed pixels and original pixels. The loop filter 608 can be made up of multiple filters. In the embodiments described below, the loop filter 608 is an ALF. Reconstructed PU x″ is then used to output a reconstructed video frame. In certain embodiments, if reconstructed PU x″ is part of a reference frame, then reconstructed PU x″ can be stored in a reference buffer 610 for reconstruction of future PUs (via, e.g., spatial-prediction block 612 or temporal-prediction block 614).

As noted with respect to FIGS. 5 and 6, entropy-coding block 510 and entropy-decoding block 602 can each implement CABAC, which is an arithmetic coding scheme that maps input symbols to a non-integer length (e.g., fractional) codeword. The efficiency of arithmetic coding depends to a significant extent on the determination of accurate probabilities for the input symbols. Thus, to improve coding efficiency, CABAC uses a context-adaptive technique in which different context models (i.e., probability models) are selected and applied for different syntax elements. Further, these context models can be updated during encoding and decoding.

Generally speaking, the process of encoding a syntax element using CABAC includes three elementary steps: (1) binarization, (2) context modeling, and (3) binary arithmetic coding. In the binarization step, the syntax element is converted into a binary sequence or bin string (if it is not already binary valued). In the context-modeling step, a context model is selected (from a list of available models per the CABAC standard) for one or more bins (i.e., bits) of the bin string. The context-model selection process can differ based on the particular syntax element being encoded as well as on the statistics of recently encoded elements. In the arithmetic coding step, each bin is encoded (via an arithmetic coder) based on the selected context model. The process of decoding a syntax element using CABAC corresponds to the inverse of these steps.

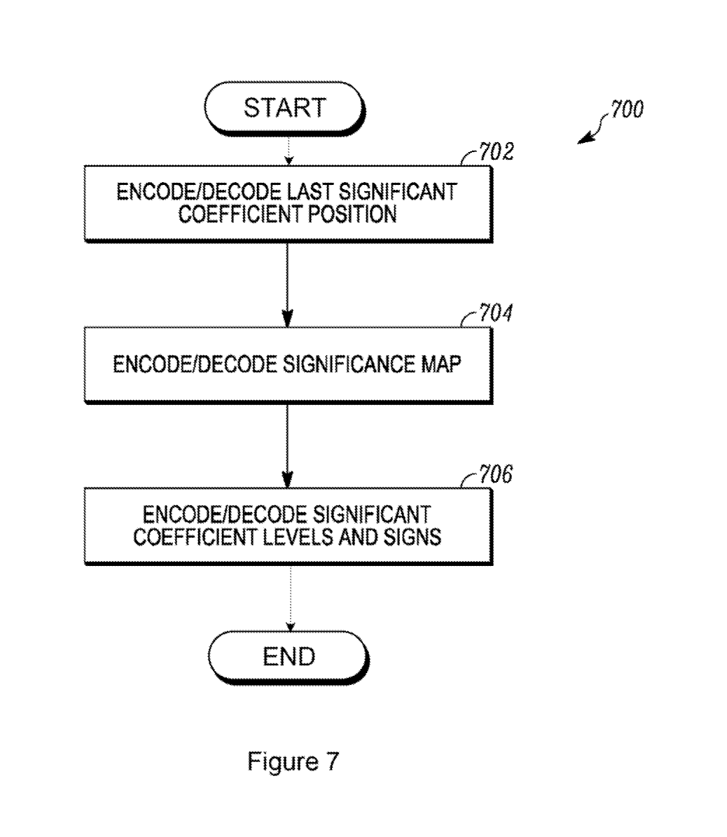

FIG. 7 depicts an exemplary coding process 700 that is performed for coding quantized transform coefficients of a residual PU (e.g., quantized PU E of FIG. 5). Process 700 can be performed by, e.g., entropy-coding block 510 of FIG. 5 or entropy-decoding block 602 of FIG. 6. In a particular embodiment, process 700 is applied to each TU associated with the residual PU.

At block 702, entropy-coding block 510 or entropy-decoding block 602 codes a last significant coefficient position that corresponds to the (y, x) coordinates of the last significant (i.e., non-zero) transform coefficient in the current TU (for a given scanning pattern).

With respect to the encoding process, block 702 includes binarizing a last_significant_coeff_y syntax element (corresponding to the y coordinate) and binarizing a last_significant_coeff_x syntax element (corresponding to the x coordinate). Block 702 further includes selecting a context model for the last_significant_coeff_y and last_significant_coeff_x syntax elements, where the context model is selected based on a predefined context index (lastCtx) and a context index increment (lastIndInc).

Once a context model is selected, the last_significant_coeff_y and last_significant_coeff_x syntax elements are arithmetically coded using the selected model.

At block 704, entropy-coding block 510 or entropy-decoding block 602 codes a binary significance map associated with the current TU, where each element of the significance map (represented by the syntax element significant_coeff_flag) is a binary value that indicates whether or not the transform coefficient at the corresponding location in the TU is non-zero. Block 704 includes scanning the current TU and selecting, for each transform coefficient in scanning order, a context model for the transform coefficient. The selected context model is then used to arithmetically code the significant_coeff_flag syntax element associated with the transform coefficient. The selection of the context model is based on a base context index (“sigCtx”) and a context index increment (“sigIndInc”). Variables sigCtx and sigIndInc are determined dynamically for each transform coefficient using a neighbor-based scheme that takes into account the transform coefficient's position as well as the significance map values for one or more neighbor coefficients around the current transform coefficient.

At block 706 of FIG. 7, entropy-coding block 510 or entropy-decoding block 602 codes the significant (i.e., non-zero) transform coefficients of the current TU. This process includes, for each significant transform coefficient, coding (1) the absolute level of the transform coefficient (also referred to as the “transform coefficient level”) and (2) the sign of the transform coefficient (positive or negative). As part of coding a transform coefficient level, entropy-coding block 510 or entropy-decoding block 602 codes three distinct syntax elements: coeff_abs_level_greater1_flag, coeff_abs_level_greater2_flag, and coeff_abs_level_remaining. Coeff_abs_level_greater1_flag is a binary value indicating whether the absolute level of the transform coefficient is greater than 1. Coeff_abs_level_greater2_flag is a binary value indicating whether the absolute level of the transform coefficient is greater than 2. And coeff_abs_level_remaining is a value equal to the absolute level of the transform coefficient minus a predetermined value (in one embodiment, this predetermined value is 3).

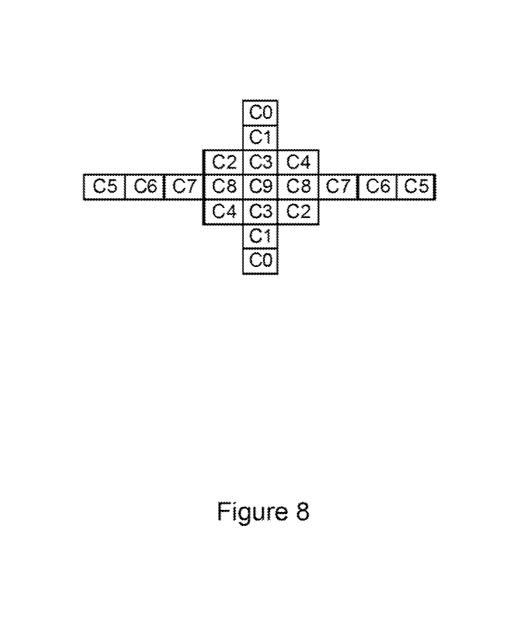

Referring back to FIG. 5 and FIG. 6, each loop filter (516 and 608) has a set of filter coefficients. Each coefficient of the set corresponds to a pixel. When either the encoder 500 or the decoder 600 processes a pixel, it applies the set of coefficients to the pixel as well as to certain neighbor pixels. Referring to FIG. 8, a group of pixels is depicted. Each pixel is represented by a block. The coefficient for the pixel is represented by the C value. For example, in FIG. 8, the pixel at the very center is the one currently being processed (the “current pixel”). Its coefficient is C9.

When processing the current pixel, the encoder or decoder performs a series of computations involving the pixel values (Luma or Chroma, ranging from 0 to 255). The computations can include multiplying each coefficient by the value of the pixel with which it is associated and summing the products. The purpose of the loop filter is to minimize coding distortion. The loop filter is applied to the reconstructed pixel for the purpose of adjusting its Luma or Chroma to be as close as possible to that of the original pixel.

In the current implementation of HEVC, the loop filter is a 10-tap symmetric two-dimensional Finite Impulse Response filter. FIG. 8 illustrates the filter shape and the coefficient distribution, where C0 . . . C9 are values for the filter coefficients.

The filter is also adaptive in that the coefficients change according to circumstances. This loop filter is referred to herein as an ALF. In FIG. 5 and FIG. 6, each loop filter (516 and 608) is an ALF in accordance with an embodiment of the disclosure.

The encoder 500 and decoder 600 binarize and code the ALF coefficients in a manner that minimizes the amount of memory used for the coefficients. Currently, HEVC binarizes and codes the ALF coefficients using fixed k parameter Exp-Golomb coding.

Table 1 is an example of a k-parameter mapping table, which maps a hypothetic set of k values for the filter of FIG. 8 to the length of the Exp-Golomb codes that correspond to the k values.

TABLE 1
Coefficient-Position Dependent ALF k-Parameters

| | | | | Maximum |
|---|---|---|---|---|
| | Filter | Coefficient | | Length (in |
| Syntax element | Coefficient | Value Range | k | bits) |
| alf_filt_coeff[0] | C0 | −256 to 255 | 1 | 17 |
| alf_filt_coeff[1] | C1 | −256 to 255 | 2 | 16 |
| alf_filt_coeff[2] | C2 | −256 to 255 | 3 | 15 |
| alf_filt_coeff[3] | C3 | −256 to 255 | 4 | 14 |
| alf_filt_coeff[4] | C4 | −256 to 255 | 3 | 15 |
| alf_filt_coeff[5] | C5 | −256 to 255 | 1 | 17 |
| alf_filt_coeff[6] | C6 | −256 to 255 | 3 | 15 |
| alf_filt_coeff[7] | C7 | −256 to 255 | 3 | 15 |
| alf_filt_coeff[8] | C8 | −256 to 255 | 5 | 13 |
| alf_filt_coeff[9] | C9 | 0 to 511 | 0 | 20 |

Currently, HEVC uses fixed k parameter Exp-Golomb coding only for ALF coefficient coding and uses other coding schemes for other types of data. For example, HEVC binarizes and codes the remainder of the absolute value of a quantized transform coefficient level, which is referred to in HEVC by the syntax coeff_abs_level_remaining, using two part coding—a unary code and a variable length code. In effect, the syntax coeff_abs_level_remaining is binarized and coded by two codewords that are combined.

The length of the variable length code depends on the unary code and a parameter k that ranges from 0 to 4.

In one embodiment, the ALF coefficient binarization and coding scheme is the same as the coeff_abs_level_remaining binarization and coding scheme. According to one implementation, the encoder 500 and the decoder 600 binarize and code the coeff_abs_level_remaining values and the ALF coefficients using the same coding scheme. In one embodiment, that coding scheme is a combination of unary coding and variable-length coding.

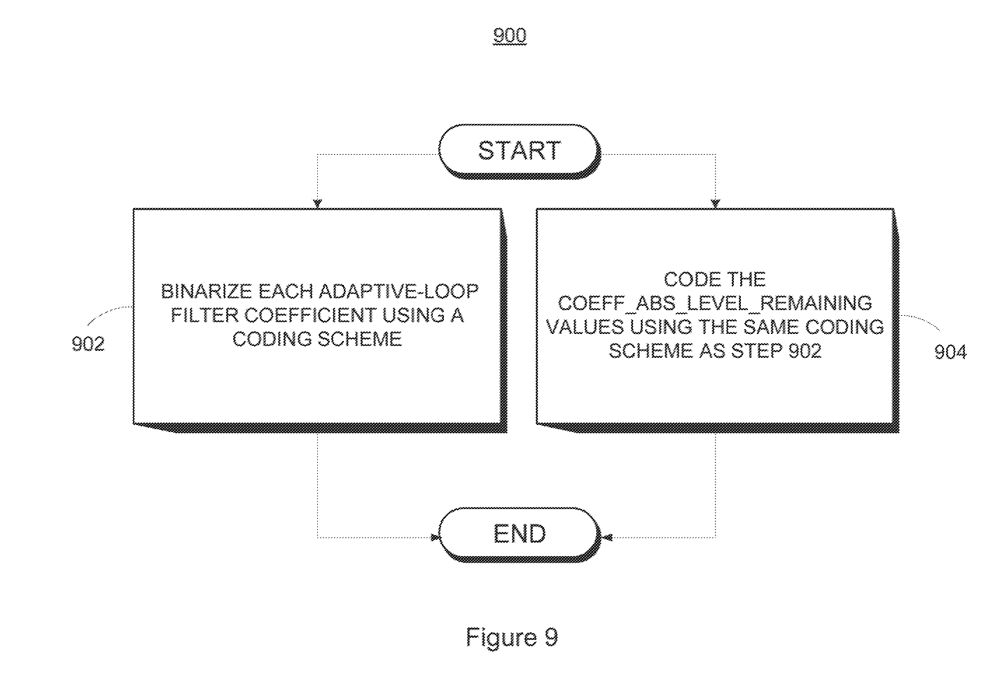

The flowchart 900 of FIG. 9 describes a process that the encoder 500 and the decoder 600 carry out in order to binarize and code ALF coefficients and coeff_abs_level_remaining values according to an embodiment. At step 902, the encoder 500 or decoder 600 binarizes each adaptive-loop filter coefficient using a coding scheme. At step 904, in parallel with step 902, the encoder 500 or decoder 600 codes the coeff_abs_level_remaining values using the same coding scheme as in step 902. In one embodiment, the coding scheme is a combination of unary coding and variable-length coding.

In various embodiments of the disclosure, the encoder 500 and the decoder 600 binarize and code the Luma ALF coefficients using the combination of unary coding and variable-length coding but with no parameter mapping table. In each embodiment, the k-parameter value can be the same for both Luma and Chroma. The k-parameter value for Luma can also be different from that of Chroma.

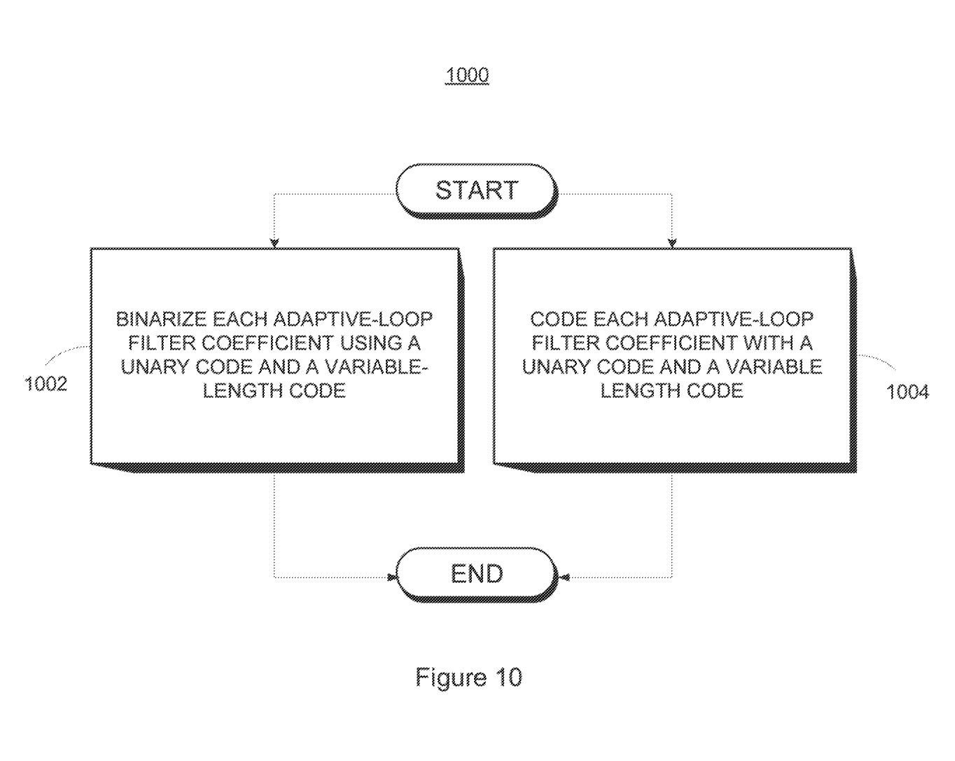

The flowchart 1000 of FIG. 10 describes a process that the encoder 500 and the decoder 600 carry out in order to binarize and code ALF coefficients without a parameter mapping table according to an embodiment. Note that the coefficients can be Luma or Chroma coefficients. At step 1002, the encoder 500 or decoder 600 binarizes each adaptive-loop filter coefficient using a unary code and a variable-length code. At step 1004, in parallel with step 1002, the encoder 500 or decoder 600 codes each adaptive-loop filter coefficient with a unary code and a variable length code. In one embodiment, the encoder 500 or decoder 600 use the same k for each ALF coefficient. Furthermore, k can be 1, 2, 3, 4, or 5.

In one embodiment, the encoder 500 and the decoder 600 binarize and code the Luma ALF coefficients using the combination of unary coding and variable-length coding and do so using the same k-parameter value for different Luma ALF coefficients at different positions, i.e., they use the same k for each pixel. In a more specific embodiment, the k-parameter value is 0, 1, 2, 3, 4, or 5.

In another embodiment, the encoder 500 and the decoder 600 binarize and code the ALF coefficients using the combination of unary coding and variable-length coding, and do so using the same k-parameter value for different Chroma ALF coefficients at different positions, i.e., they use the same k for each pixel. In a more specific embodiment, the k-parameter value can be 0, 1, 2, 3, 4 or 5.

In yet another embodiment, the encoder 500 and the decoder 600 binarize and code the ALF coefficients without a parameter mapping table for the Luma ALF coefficients. In this embodiment, the encoder 500 and the decoder 600 binarize and code the Luma ALF coefficients with k-variable Exp-Golomb codewords, where k is larger than 0. In other words, the encoder 500 and the decoder 600 use the same k parameter for all Luma ALF coefficients but use k values greater than 0.

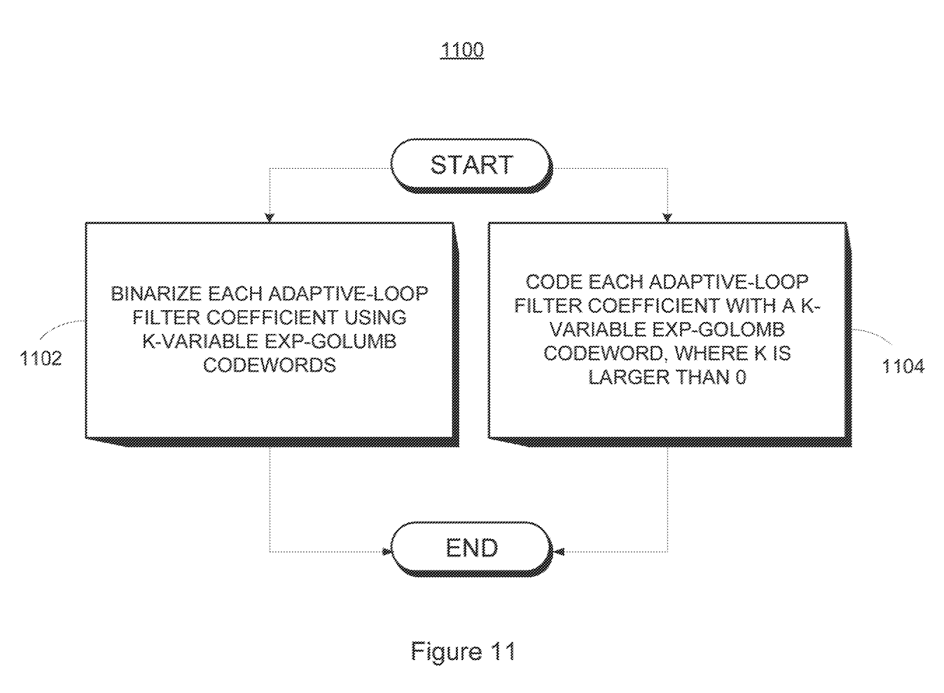

The flowchart 1100 of FIG. 11 describes a process that the encoder 500 and the decoder 600 carry out in order to binarize and code ALF coefficients without a parameter mapping table according to an embodiment. At step 1102, the encoder 500 or decoder 600 binarizes each adaptive-loop filter coefficient using k-variable Exp-Golumb codewords. At step 1104, in parallel with step 1102, the encoder 500 or decoder 600 codes each adaptive-loop filter coefficient with a k-variable Exp-Golomb codeword, where k is larger than 0.

In a further embodiment, the encoder 500 and the decoder 600 binarize and code the Luma ALF coefficients with k-variable Exp-Golomb codewords, where k is 1, 2, 3, 4, 5, or larger. In other words, the encoder 500 and the decoder 600 use the same k parameter for all Luma ALF coefficients but use k values of 1, 2, 3, 4, 5, or larger.

In still another embodiment, the encoder 500 and the decoder 600 binarize and code the Chroma ALF coefficients with k-variable Exp-Golomb codewords, where k is 1, 2, 3, 4, 5, or larger. In other words, the encoder and decoder use the same k parameter for all Luma ALF coefficients but use k values of 1, 2, 3, 4, 5, or larger.

In yet another embodiment, the encoder 500 and the decoder 600 binarize and code all of the Luma ALF coefficients with fixed-length codewords where the length (in bits) is 4, 5, 6, 7, 8, or larger.

In a further embodiment, the encoder 500 and the decoder 600 binarize and code all of the Chroma ALF coefficients with fixed-length codewords where the length (in bits) is 4, 5, 6, 7, 8, or larger.

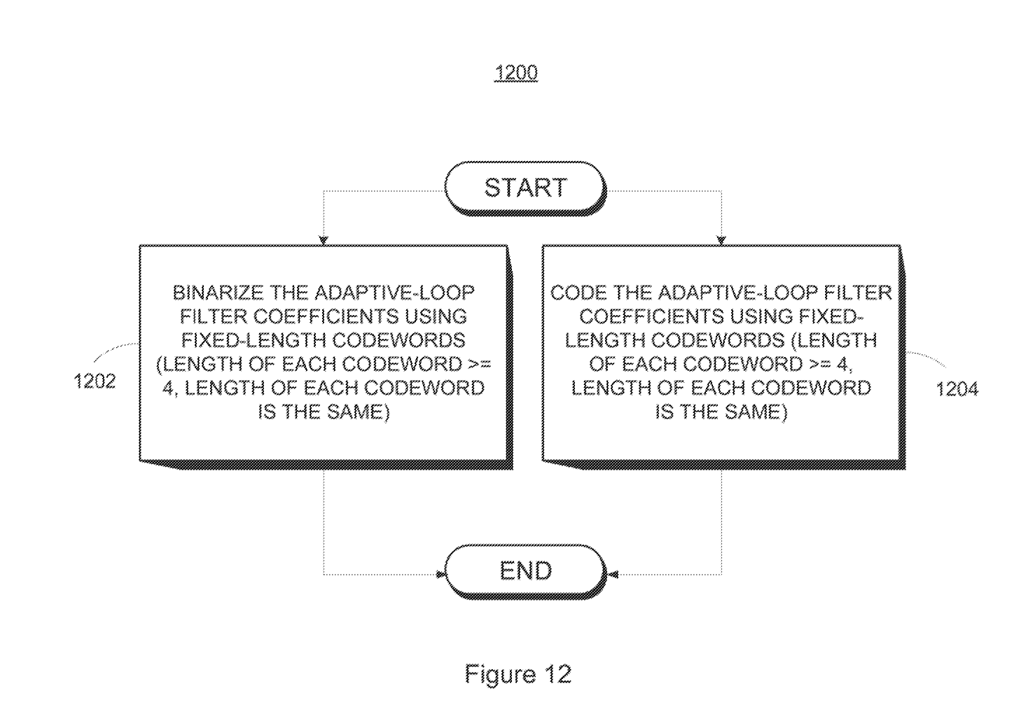

The flowchart 1200 of FIG. 12 describes a process that the encoder 500 and the decoder 600 carry out in order to binarize and code ALF coefficients without a parameter mapping table according to an embodiment. The ALF coefficients can be Luma or Chroma. At step 1202, the encoder 500 or decoder 600 binarizes the adaptive-loop filter coefficients using fixed-length codewords, in which the length of each codeword is greater than or equal to 4, and the length of each codeword is the same. At step 1204, in parallel with step 1202, the encoder 500 or decoder 600 codes the adaptive-loop filter coefficients using fixed-length codewords, in which the length of each codeword is greater than or equal to 4, and the length of each codeword is the same.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method for coding a plurality of adaptive-loop filter coefficients, the method comprising:
binarizing each of the plurality of adaptive-loop filter coefficients using k-variable Exp-Golomb codewords for which k is larger than 0; and
coding each of the plurality of adaptive-loop filter coefficients with k-variable Exp-Golomb codewords for which k is greater than 0.

2. The method of claim 1 wherein the value of k used for coding each of the plurality of adaptive-loop filter coefficients is the same for each of the plurality of adaptive-loop filter coefficients.

3. The method of claim 1:
wherein the value of k used for binarizing each of the plurality of adaptive-loop filter coefficients is selected from a group consisting of: 1, 2, 3, 4, and 5; and
wherein the value of k used for coding each of the plurality of adaptive-loop filter coefficients is selected from a group consisting of: 1, 2, 3, 4, and 5.

4. The method of claim 1 wherein each of the plurality of adaptive-loop filter coefficients is a Luma adaptive-loop filter coefficient.

5. The method of claim 4:
wherein the value of k used for binarizing each of the plurality of adaptive-loop filter coefficients is selected from a group consisting of: 1, 2, 3, 4, and 5; and
wherein the value of k used for coding each of the plurality of adaptive-loop filter coefficients is selected from a group consisting of: 1, 2, 3, 4, and 5.

6. The method of claim 1 wherein each of the plurality of adaptive-loop filter coefficients is a Chroma adaptive-loop filter coefficient.

7. The method of claim 6:
wherein the value of k used for binarizing each of the plurality of adaptive-loop filter coefficients is selected from a group consisting of: 1, 2, 3, 4, and 5; and
wherein the value of k used for coding each of the plurality of adaptive-loop filter coefficients is selected from a group consisting of: 1, 2, 3, 4, and 5.

8. A method for coding a plurality of adaptive-loop filter coefficients, the method comprising:
binarizing the plurality of adaptive-loop filter coefficients using fixed-length codewords, all of which have a length that is equal to or greater than 4 bits; and
coding each of the plurality of adaptive-loop filter coefficients using fixed-length codewords, all of which have a length that is equal to or greater than 4 bits.

9. The method of claim 8:
wherein the length of each of the fixed-length codewords used to binarize the plurality of adaptive-loop coefficients is selected from a group consisting of: 4 bits, 5 bits, 6 bits, 7 bits, and 8 bits; and
wherein the length of each of the fixed-length codewords used to code the plurality of adaptive-loop coefficients is selected from a group consisting of: 4 bits, 5 bits, 6 bits, 7 bits, and 8 bits.

10. The method of claim 8 wherein each of the plurality of adaptive-loop filter coefficients is a Luma adaptive-loop filter coefficient.

11. The method of claim 10:
wherein the length of each of the fixed-length codewords used to binarize the plurality of adaptive-loop coefficients is selected from a group consisting of: 4 bits, 5 bits, 6 bits, 7 bits, and 8 bits; and
wherein the length of each of the fixed-length codewords used to code the plurality of adaptive-loop coefficients is selected from a group consisting of: 4 bits, 5 bits, 6 bits, 7 bits, and 8 bits.

12. The method of claim 8 wherein each of the plurality of adaptive-loop filter coefficients is a Chroma adaptive-loop filter coefficient.

13. The method of claim 12:
wherein the length of each of the fixed-length codewords used to binarize the plurality of adaptive-loop coefficients is selected from a group consisting of: 4 bits, 5 bits, 6 bits, 7 bits, and 8 bits; and
wherein the length of each of the fixed-length codewords used to code the plurality of adaptive-loop coefficients is selected from a group consisting of: 4 bits, 5 bits, 6 bits, 7 bits, and 8 bits.

14. An encoder for encoding a plurality of original video pixels of an original predictive unit, the encoder comprising:
an adaptive-loop filter configured to minimize the coding distortion between input and output pictures, wherein the adaptive-loop filter has a plurality of filter coefficients, wherein each of the filter coefficients is binarized using k-variable Exp-Golomb codewords for which k is larger than 0, and wherein each of the filter coefficients is coded using k-variable Exp-Golomb codewords for which k is greater than 0.
